(19) United States
(12) Patent Application Publication
(10) Pub. No.: US 2019/0014261 A1
(43) Pub. Date: Jan. 10, 2019

(54) PHOTOGRAPHING METHOD AND PHOTOGRAPHING SYSTEM COMPATIBLE IN AIR AND WATER

(71) Applicant: Sky Light Electronic (Shenzhen) Limited Corporation, Shenzhen, Guangdong (CN)

(72) Inventors: Yanbo Gong, Shenzhen, Guangdong (CN); Weijun Gan, Shenzhen, Guangdong (CN); Qunfu Yao, Shenzhen, Guangdong (CN); Rong Zhou, Shenzhen, Guangdong (CN)

(73) Assignee: Sky Light Electronic (Shenzhen) Limited Corporation, Shenzhen, Guangdong (CN)

(21) Appl. No.: 16/068,118

(22) PCT Filed: Oct. 20, 2016
(86) PCT No.: PCT/CN2016/102750

§ 371 Date: Jul. 4, 2018

(51) Int. Cl. H04N 5/232; G06T 7/80; G06T 3/40; H04N 5/247; G06K 9/00

(52) U.S. Cl. CPC H04N 5/23245; H04N 5/23238; H04N 5/23216; G06K 9/00664; G06T 3/4038; H04N 5/247; G06T 7/80

(57) ABSTRACT

A photographing method compatible in air and water, comprising the following steps: step 1, starting the camera; step 2, identifying the parameters for the current application scene automatically or manually by the camera and acquiring image; step 3, correlating the acquired image with stored parameters for application scene; step 4, retrieving the stored parameters for application scene corresponding to the acquired image, and inputting a parametric model corresponding to a stored application scene into the image splicing algorithm to perform splicing, to synthesize a panoramic image. The photographing method receives image information in air and water respectively by camera and calculates parameters which have influence on the image stitching, or uses an optical lens to simulate and calculate photographing parameters for air application for a lens in air and photographing parameters for water application for a lens in water.

### TECHNICAL FIELD

The present application relates to the field of photographing, and more particularly, to a photographing method and photographing system compatible in air and water.

### BACKGROUND

The precondition for realizing accurate mosaic of 360° panoramic camera (without mistake) is that the image information acquired by the camera could meet the requirements of mosaic. When a camera with two lenses realizes 360° panoramic stitching, both of the required viewing angle range of two lenses should be greater than 180°, and even reach a certain value, thus realizing accurate mosaic. By analyzing the optical simulation data, it was found: because the incident media is different, the parameters acquired by the camera lens, such as FOV (field of view angle), IMAGE CIRCLE (size of image plane), Relative illumination, and MTF (optical transfer function) and so on, are not the same. However, these parameters will have a direct influence on the accuracy of the stitching algorithm, resulting in stitching error when the camera annularly shoots image, thus unable to obtain a 360° panoramic image.

At present, the 360° panoramic camera on the market could only be used on land, or could only be used in water. On the condition of no change of hardware, it can't realize 360° panoramic photography on land and in water at the same time. The key reason of being unable to simultaneously realize 360° panoramic photography on land and in water is that stitching errors occur when the camera annularly shoots image, which makes it unable to obtain a 360° panoramic image, because the basis of the stitching algorithm is whether the camera lens and COMS are accurate and consistent when collecting image information. When the equipment is used on land and in water respectively, the parameters obtained by the optical lens, which have important influence on the image stitching, will change, and that's the key reason why the hardware could not be simultaneously and normally used in water and on land.

Therefore, it is necessary to develop a 360° panoramic camera or multi-camera annular photographing device which is compatible with photographing method and system in air and water, so as to solve the problem that 360° panoramic camera or multi-camera annular photographing device could not be directly and simultaneously meet the stitching requirements on land and in water, achieving the purpose of amphibious use.

### SUMMARY

To overcome the deficiencies of the prior art, the embodiments of the present application provide a photographing method and photographing system compatible in air and water.

The embodiments of the present application comprise the following technical solutions:

A photographing method compatible in air and water, comprising the following steps:

step 1, starting the camera;

step 2, identifying the parameters for the current application scene automatically or manually by the camera and acquiring image;

step 3, correlating the acquired image with stored parameters for application scene;

step 4, retrieving the stored parameters for application scene corresponding to the acquired image, and inputting a parametric model corresponding to a stored application scene into the image splicing algorithm to perform splicing, to synthesize a panoramic image.

Further, an acquisition process of the stored parameters for application scene comprises the following contents:

starting a camera, the camera acquires optical information in air and water respectively and image information photographed in a calibration environment in air and water respectively, and then calculates the parameters that have an important influence on the splicing, or using an optical lens to simulate and calculate the parameters for air application scene of the lens in the air and the parameters for water application scene of the lens;

respectively generating parametric model required when photographing application scene in air and water by the camera, and storing the parametric model in the camera's memory.

Further, the camera identifies the photographing application scene by an automatic mode or a manual mode and correlates and retrieves the parameters for application scene, wherein the automatic mode is an identification mode by an image sensor, or an identification mode in which lens simulates and calculates the parameters for air application scene and the parameters for water application scene, comprising the following specific steps:

step 1, starting the camera, and determining whether the camera is a manual mode of switching the parametric model; if it's a manual mode of switching the parametric model, then proceed to step 7, if it's not a manual mode of switching the parametric model, then proceed to the next step;

step 2, receiving the optical information parameters of the current external environment by the image sensor, or simulating and calculating the parameters for current air application scene and the parameters for water application scene by the lens;

step 3, comparing the current optical information parameters or the parameters for current air application scene and the parameters for water application scene simulated and calculated by the lens with the corresponding parameters in the parametric model stored in the camera;

step 4, comparing the current optical information parameters or the parameters for current air application scene simulated and calculated by the lens with the corresponding parameters in the stored air parametric model; if the difference value is less than a set value, then proceed to the next step; if the difference value is greater than the set value, then proceed to step 6;

step 5, correlating the acquired image with the stored parameters for air application scene, and retrieving the stored air parametric model;

step 6, correlating the acquired image with the stored parameters for water application scene, and retrieving the stored water parametric model;

step 7, manually switching the camera to an air parametric model, correlating the acquired image with the stored parameters for air application scene and retrieving the stored air parametric model, or manually switching the camera to a water parametric model, correlating the acquired image with the stored parameters for water application scene and retrieving the stored water parametric model.

Further, the camera identifies the photographing application scene by an automatic mode or a manual mode and correlates and retrieves the parameters for application scene, wherein the automatic mode is an identification mode by an external sensor, and the external sensor is used to identify whether the camera is in a photographing scene in water, comprising the following specific steps:

step 1, starting the camera, determining whether the camera is a manual mode of switching the parametric model; if it is a manual mode of switching the parametric model, then proceed to step 5, if it's not a manual mode of switching the parametric model, then proceed to the next step;

step 2, detecting whether the camera is currently in a photographing scene in water by the external sensor, if not, proceed to the next step; if yes, proceed to step 4;

step 3, correlating the acquired image with stored parameters for air application scene, and retrieving the stored air parametric model;

step 4, correlating the acquired image with the stored parameters for water application scene, and retrieving the stored water parametric model;

step 5, manually switching the camera to an air parametric model, correlating the acquired image with the stored parameters for air application scene and retrieving the stored air parametric model, or manually switching the camera to a water parametric model, correlating the acquired image with the stored parameters for water application scene and retrieving the stored water parametric model.

Further, the parameters for water application scene comprise parameters for seawater application scene and parameters for freshwater application scene.

Further, the set value is 3%-10%.

Further, the external sensor comprises a pressure sensor or a waterlogging sensor.

Further, the camera is a photographing device A or a photographing device B;

the photographing device A comprises two or more photographing units, and the photographing unit comprises an image sensor; the photographing device A further comprises a main control unit, and the main control unit comprises a main controller, and a main memory connected with the main controller;

the photographing device B comprises two or more photographing units, and the photographing unit comprises an image sensor and an image processor and an image memory that are electrically connected with the image sensor.

A photographing system compatible in air and water, comprising a photographing system A or a photographing system B;

the photographing system A comprises a main control unit and two or more photographing units connected with the main control unit; the photographing unit comprises an image sensor, and an image processor and an image memory that are electrically connected with the image sensor, and an I/O subassembly connected with the image processor; the main control unit comprises a main controller, and a main memory connected with the main controller; and a parametric model for photographing in water and a parametric model for photographing in air are stored in the image memory of the photographing unit or in the main memory of the main control unit;

the photographing system B comprises two or more photographing units; the photographing unit comprises an image sensor, and an image processor and an image memory that are electrically connected with the image sensor, and a parametric model for photographing in water and a parametric model for photographing in air are stored in the image memory of the photographing unit.

A photographing system compatible in air and water, comprising a photographing system A or a photographing system B;

the photographing system A comprises a main control unit and two or more photographing units connected with the main control unit; the photographing unit comprises an image sensor; the main control unit comprises a main controller, and a main memory connected with the main controller; the main control unit also comprises an external sensor connected with the main controller, and the external sensor comprises a waterlogging sensor or a pressure sensor;

the photographing system B comprises two or more photographing units; the photographing unit comprises an image sensor, and an image processor and an image memory that are electrically connected with the image sensor; the photographing unit also comprises an external sensor connected with the image processor, and the external sensor comprises a waterlogging sensor or a pressure sensor.

Compared with the prior art, the embodiments of the present application may have the following beneficial effects: receiving image information in air and water respectively by camera and calculating parameters which have influence on the image stitching, or using an optical lens to simulate and calculate photographing parameters for air application for the lens in air and photographing parameters for water application for a lens in water, the embodiments of the present application may realize that the camera could photograph panoramic photo in both of air and water, so as to reduce the repetitive investment cost of hardware of the camera.

The present application is further described in detail below with reference to the accompanying drawings and embodiments.

### BRIEF DESCRIPTION OF THE DRAWINGS

FIG. 1 is a flowchart of a photographing method compatible in air and water of the first embodiment;

FIG. 2 is a flowchart of a photographing method compatible in air and water of the second embodiment;

FIG. 3 is a flowchart of parameter retrieval of the identification mode of image sensor or simulation and calculation of lens;

FIG. 4 is a flowchart of parameter retrieval of external sensor identification mode;

FIG. 5 is a block diagram of a photographing system A of a photographing system compatible in air and water of the first embodiment;

FIG. 6 is a block diagram of a photographing system B of a photographing system compatible in air and water of the first embodiment;

FIG. 7 is a block diagram of a photographing system A of a photographing system compatible in air and water of the second embodiment;

FIG. 8 is a block diagram of a photographing system B of a photographing system compatible in air and water of the second embodiment.

The description of references in the drawings:

“10” represents a photographing unit; “11” represents an I/O subassembly;

“12” represents an image processor; “13” represents an image sensor;

“14” represents an image memory; “20” represents a main control unit;

“21” represents a main controller; “22” represents a main memory;

“23” represents a waterlogging sensor; “24” represents a pressure sensor.

### DETAILED DESCRIPTION

In order to more fully understand the technical content of the present application, the technical solutions of the present application are further described and illustrated below with reference to embodiments, but are not limited thereto.

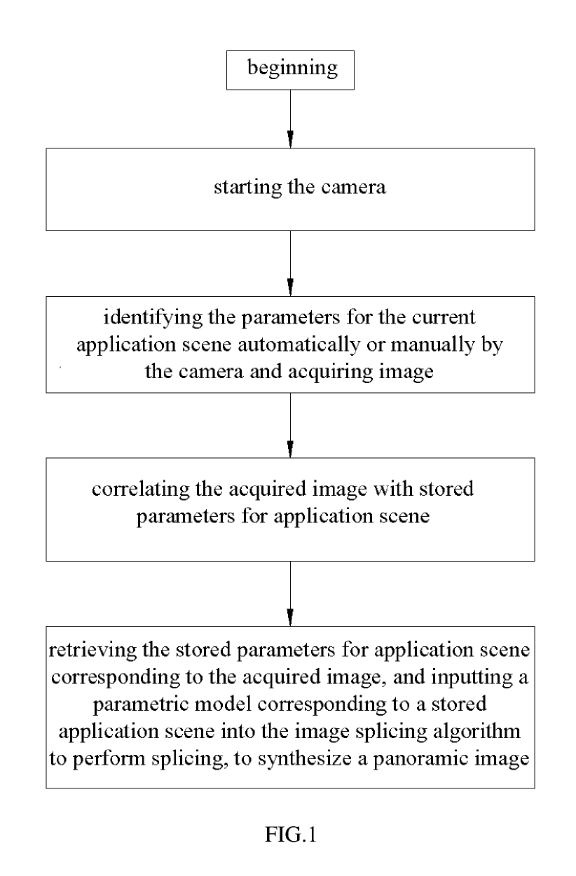

As shown in the embodiments shown in FIG. 1 to FIG. 8, a photographing method compatible in air and water of the first embodiment of the present application, as shown in FIG. 1, comprises the following steps:

Step 1, starting a camera;

Step 2, the camera automatically or manually identifies the parameters for the current application scene (in the present embodiment, the parameters for application scene comprise the parameters calculated from optical information and image information photographed in a calibration environment, the parameters calculated by simulation of an optical lens) and acquires image;

Step 3, correlating the acquired image with stored parameters for application scene;

Step 4, retrieving the stored parameters for application scene corresponding to the acquired image, and inputting a parametric model corresponding to a stored application scene into the image splicing algorithm to perform splicing, to synthesize a panoramic image.

Wherein, for the step 2, the step that the camera automatically or manually identifies the parameters for the current application scene and acquires image comprises the following three methods, and the specific methods are as follows:

1, The camera automatically or manually identifies the parameters for the current application scene first, and then acquires the image.

2, The camera acquires the image first, and then automatically or manually identifies the parameters for the current application scene;

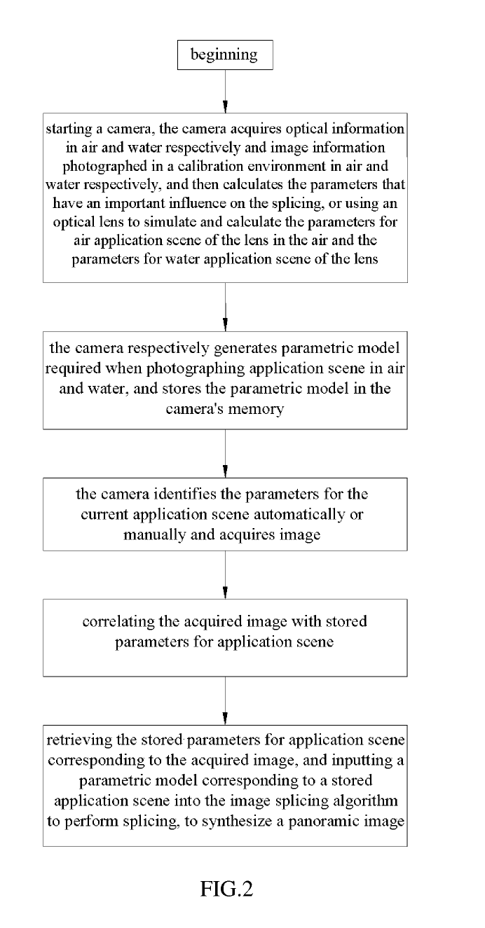

3, The camera acquires the image while automatically or manually identifying the parameters for the current application scene.

Wherein, as shown in FIG. 2, a photographing method compatible in air and water of the second embodiment of the present application. The difference between the second embodiment and the first embodiment lies in: the acquisition process of the stored parameters for application scene comprises the following steps:

Starting a camera, the camera acquires the optical information in air and water respectively and the image information photographed in a calibration environment in air and water respectively, and then calculates the parameters that have an important influence on the stitching. Or, using the optical lens to simulate and calculate the parameters for air application scene of the lens and the parameters for water application scene of the lens;

The camera respectively generates parametric model required when photographing application scene in air and water, and stores the parametric model in the camera's memory.

Wherein, the calculation of the parameters for air application scene and water application scene comprises the following six conditions:

1, Calculate the parameters for water application scene, and the parameters for air application scene are known;

2, Calculate the parameters for air application scene, and the parameters for water application scene are known;

3, Calculate the photographing parameters in air by simulation, and the parameters of lens in air are known;

4, Calculate the photographing parameters in water by simulation, and the parameters of lens in water are known;

5, Calculate the photographing parameters in water by simulation, and the parameters of lens in air are known;

6, Calculate the photographing parameters in air by simulation, and the parameters of lens in water are known.

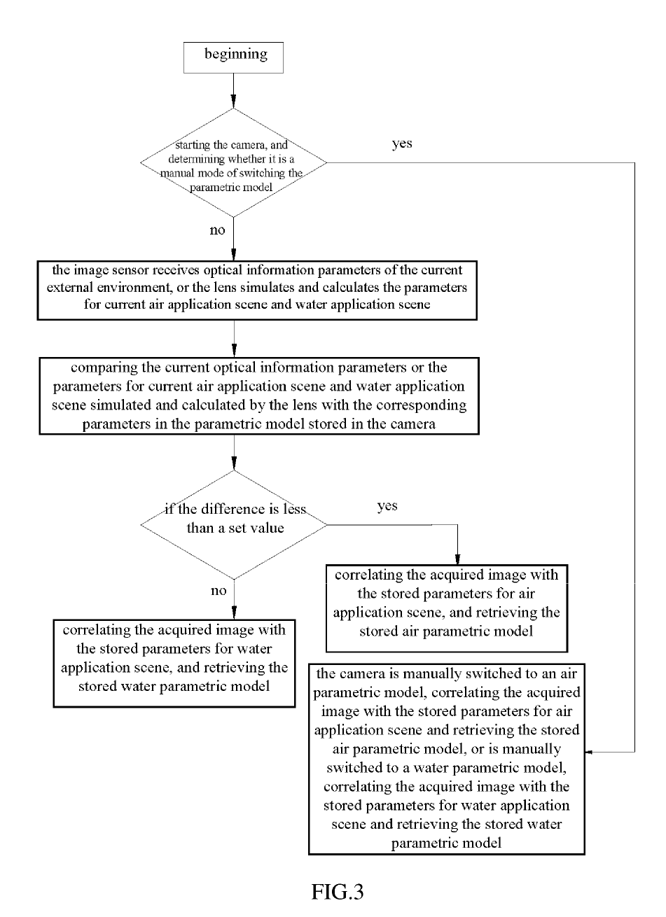

Specifically, as shown in FIG. 3, the camera identifies the photographing application scene by an automatic mode or a manual mode and correlates and retrieves the parameters for application scene, wherein the automatic mode is an identification mode by an image sensor, or an identification mode in which lens simulates and calculates the parameters for air application scene and the parameters for water application scene, which comprises the following specific steps:

Step 1, starting the camera, and determining whether the camera is a manual mode of switching the parametric model; if it's a manual mode of switching the parametric model, then proceed to step 7, if it's not a manual mode of switching the parametric model, then proceed to the next step;

Step 2, the image sensor receives optical information parameters of the current external environment, or the lens simulates and calculates the parameters for current air application scene and the parameters for water application scene;

Step 3, comparing the current optical information parameters or the parameters for current air application scene and the parameters for water application scene simulated and calculated by the lens with the corresponding parameters in the parametric model stored in the camera;

Step 4: comparing the current optical information parameters or the parameters for current air application scene simulated and calculated by the lens with the corresponding parameters in the stored air parametric model; if the difference value is less than a set value, then proceed to the next step; if the difference value is greater than the set value, then proceed to step 6;

Step 5, correlating the acquired image with the stored parameters for air application scene, and retrieving the stored air parametric model;

Step 6, correlating the acquired image with the stored parameters for water application scene, and retrieving the stored water parametric model;

Step 7: the camera is manually switched to an air parametric model, correlating the acquired image with the stored parameters for air application scene and retrieving the stored air parametric model, or is manually switched to a water parametric model, correlating the acquired image with the stored parameters for water application scene and retrieving the stored water parametric model.

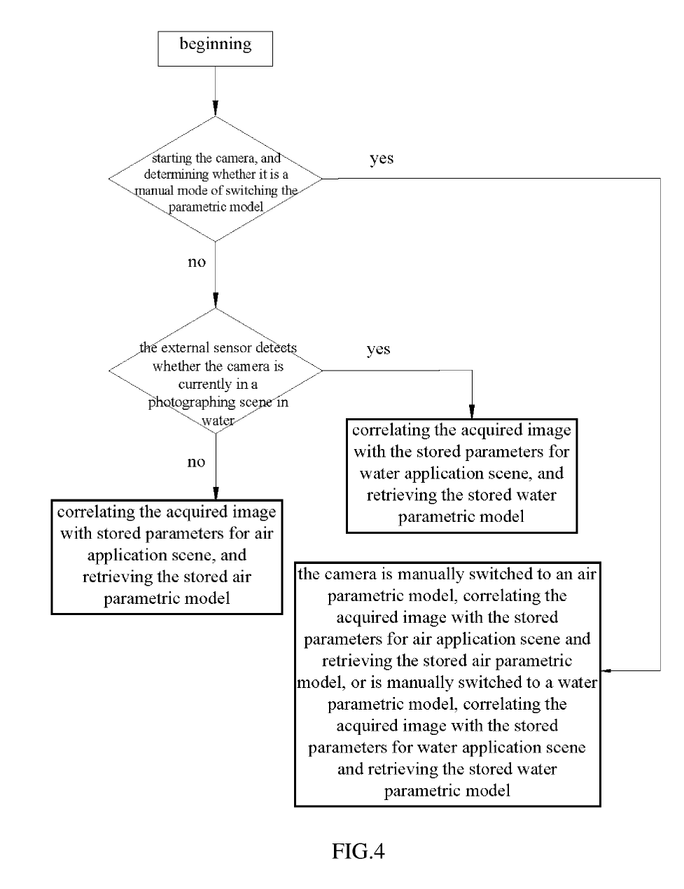

As shown in FIG. 4, the camera identifies the photographing application scene by an automatic mode or a manual mode and correlates and retrieves the parameters for application scene, wherein the automatic mode is an identification mode by an external sensor, and the external sensor is used to identify whether the camera is in a photographing scene in water, comprising the following specific steps:

Step 1, starting the camera, determining whether the camera is a manual mode of switching the parametric model; if it is a manual mode of switching the parametric model, then proceed to step 5, if it's not a manual mode of switching the parametric model, then proceed to the next step;

Step 2, the external sensor detects whether the camera is currently in a photographing scene in water, if not, proceed to the next step; if yes, proceed to step 4;

Step 3: correlating the acquired image with stored parameters for air application scene, and retrieving the stored air parametric model;

Step 4: correlating the acquired image with the stored parameters for water application scene, and retrieving the stored water parametric model;

Step 5: the camera is manually switched to an air parametric model, correlating the acquired image with the stored parameters for air application scene and retrieving the stored air parametric model, or is manually switched to a water parametric model, correlating the acquired image with the stored parameters for water application scene and retrieving the stored water parametric model.

Specifically, as shown in FIG. 1 to FIG. 8, the photographing parameters in water comprise parameters for seawater application scene and parameters for freshwater application scene, and the set value is 3%-10%; the external sensor comprises a pressure sensor or a waterlogging sensor.

Specifically, as shown in FIG. 1 to FIG. 8, the camera is a photographing device A or a photographing device B;

The photographing device A comprises two or more photographing units 10, and the photographing unit 10 comprises an image sensor 13; the photographing device A further comprises a main control unit 20, the main control unit 20 comprises a main controller 21, and a main memory 22 connected with the main controller 21;

The photographing device B comprises two or more photographing units 10, and the photographing unit 10 comprises an image sensor 13 and an image processor 12 and an image memory 14 that are electrically connected with the image sensor 13.

The above methods will change in the use, especially different areas of the water environment vary; in order to have better adaptability, in the use, according to the image data after photographing, the photographing parameters could be manually adjusted or automatically adjusted. Or send unsatisfactory image data (i.e., photos) to the server by wireless communication or wired communication, and adjust the image parameters by the server; after the adjustment, the server converts the image parameters to new photographing parameters, and the camera could use the new photographing parameters, to continuously improve the data of the photographing model (or be called photographing parameters) to improve the quality of photos. The above adjustment could be achieved either by the server or by the operation of the camera itself.

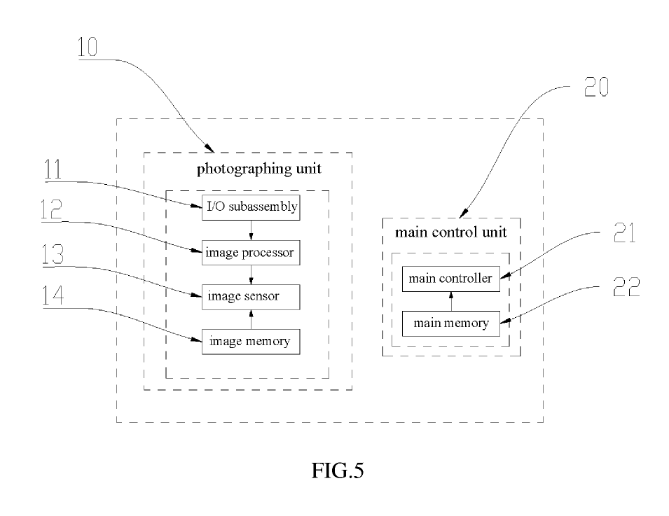

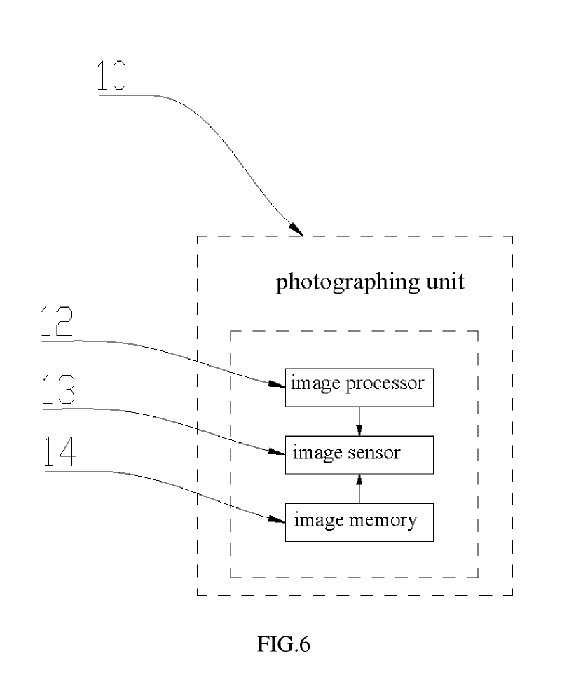

As shown in FIG. 5 to FIG. 6, the present application also discloses a photographing system compatible in air and water, in the first embodiment, comprising a photographing system A or a photographing system B.

As shown in FIG. 5, the photographing system A comprises a main control unit 20 and two or more photographing units 10 connected with the main control unit 20. The photographing unit 10 comprises an image sensor 13, and an image processor 12 and an image memory 14 that are electrically connected with the image sensor 13, and an I/O subassembly 11 connected with the image processor 12; the main control unit 20 comprises a main controller 21 and a main memory 22 connected with the main controller 21; and a parametric model for photographing in water and a parametric model for photographing in air are stored in the image memory 14 of the photographing unit 10 or in the main memory 22 of the main control unit 20;

As shown in FIG. 6, the photographing system B comprises two or more photographing units 10; the photographing unit 10 comprises an image sensor 13, and an image processor 12 and an image memory 14 that are electrically connected with the image sensor 13, and a parametric model for photographing in water and a parametric model for photographing in air are stored in the image memory 14 of the photographing unit 10.

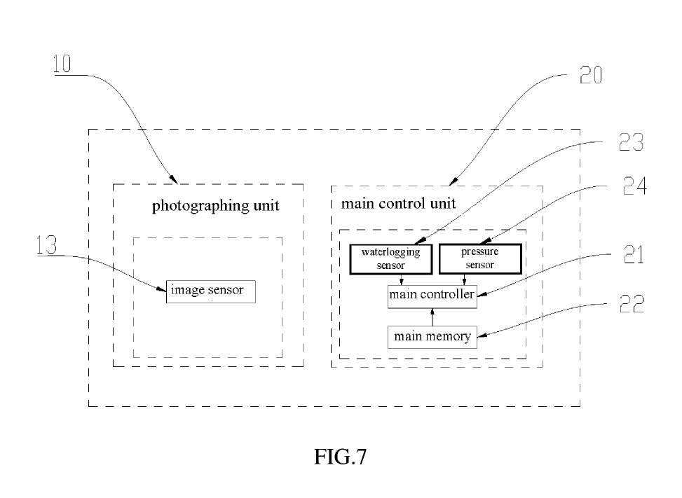

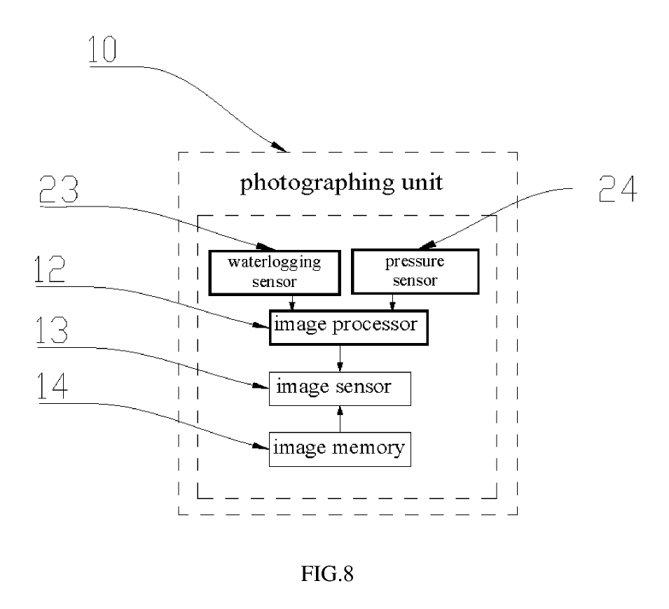

As shown in FIG. 7 to FIG. 8, a photographing system compatible in air and water of the second embodiment comprises a photographing system A or a photographing system B.

As shown in FIG. 7, the photographing system A comprises a main control unit 20 and two or more photographing units 10 connected with the main control unit 20. The photographing unit 10 comprises an image sensor 13; the main control unit 20 comprises a main controller 21, and a main memory 22 connected with the main controller 21; the main control unit 20 also comprises an external sensor connected with the main controller 21, and the external sensor comprises a waterlogging sensor 23 or a pressure sensor 24;

As shown in FIG. 8, the photographing system B comprises two or more photographing units 10; the photographing unit 10 comprises an image sensor 13 and an image processor 12 and an image memory 14 that are electrically connected with the image sensor 13; the photographing unit 10 also comprises an external sensor connected with the image processor 12, and the external sensor comprises a waterlogging sensor 23 or a pressure sensor 24.

Wherein, the external sensor is disposed on the surface of the shell of the camera. When the camera is in the water environment, when the pressure sensor 24 is used, the pressure sensor 24 could detect the water pressure and then output the corresponding signal to the main controller 21, so as to switch the photographing parametric model of the photographing unit 10. When the waterlogging sensor 23 is used, after being soaked by water, the waterlogging sensor 23 could trigger a corresponding signal to the main controller 21, so as to switch the photographing parametric model of the photographing unit 10. Since the water is divided into seawater environment and freshwater environment, the sensor measuring pH value could be further used, to distinguish whether the camera is in seawater environment or freshwater environment, so that the photographing parametric model of the photographing unit could be accordingly selected between seawater model and freshwater model.

In summary, the photographing method and photographing system compatible in air and water of the present application, receive image information in air and water respectively by camera and calculate parameters which have influence on the image stitching, or use an optical lens to simulate and calculate photographing parameters for air application for the lens in air and photographing parameters for water application for the lens in water, so that the camera could photograph panoramic photo in both of air and water, so as to reduce the repetitive investment cost of hardware of the camera.

The foregoing describes the technical content of the present application merely through embodiments, so as to facilitate the reader's understanding. However, it does not mean that the embodiments of the present application are only limited to these descriptions. Any technical extension or re-creation made according to the present application should be considered to fall into the protection scope of the present application. The protection scope of the present application is subject to the claims.

1. A photographing method compatible in air and water, comprising the following steps:
step 1, starting the camera;
step 2, identifying the parameters for the current application scene automatically or manually by the camera and acquiring image;
step 3, correlating the acquired image with stored parameters for application scene;
step 4, retrieving the stored parameters for application scene corresponding to the acquired image, and inputting a parametric model corresponding to a stored application scene into the image splicing algorithm to perform splicing, to synthesize a panoramic image.

2. The photographing method compatible in air and water according to claim 1, wherein an acquisition process of the stored parameters for application scene comprises the following contents:
starting a camera, the camera acquires optical information in air and water respectively and image information photographed in a calibration environment in air and water respectively, and then calculates the parameters that have an important influence on the splicing, or using an optical lens to simulate and calculate the parameters for air application scene of the lens in the air and the parameters for water application scene of the lens;
respectively generating parametric model required when photographing application scene in air and water by the camera, and storing the parametric model in the camera's memory.

3. The photographing method compatible in air and water according to claim 2, wherein the camera identifies the photographing application scene by an automatic mode or a manual mode and correlates and retrieves the parameters for application scene, wherein the automatic mode is an identification mode by an image sensor, or an identification mode in which lens simulates and calculates the parameters for air application scene and the parameters for water application scene, comprising the following specific steps:
step 1, starting the camera, and determining whether the camera is a manual mode of switching the parametric model; if it's a manual mode of switching the parametric model, then proceed to step 7, if it's not a manual mode of switching the parametric model, then proceed to the next step;
Step 2, receiving the optical information parameters of the current external environment by the image sensor, or simulating and calculating the parameters for current air application scene and the parameters for water application scene by the lens;
step 3, comparing the current optical information parameters or the parameters for current air application scene and the parameters for water application scene simulated and calculated by the lens with the corresponding parameters in the parametric model stored in the camera;
step 4, comparing the current optical information parameters or the parameters for current air application scene simulated and calculated by the lens with the corresponding parameters in the stored air parametric model; if the difference value is less than a set value, then proceed to the next step; if the difference value is greater than the set value, then proceed to step 6;
step 5, correlating the acquired image with the stored parameters for air application scene, and retrieving the stored air parametric model;
step 6, correlating the acquired image with the stored parameters for water application scene, and retrieving the stored water parametric model;
step 7, manually switching the camera to an air parametric model, correlating the acquired image with the stored parameters for air application scene and retrieving the stored air parametric model, or manually switching the camera to a water parametric model, correlating the acquired image with the stored parameters for water application scene and retrieving the stored water parametric model.

4. The photographing method compatible in air and water according to claim 1, wherein the camera identifies the photographing application scene by an automatic mode or a manual mode and correlates and retrieves the parameters for application scene, wherein the automatic mode is an identification mode by an external sensor, and the external sensor is used to identify whether the camera is in a photographing scene in water, comprising the following specific steps:
step 1, starting the camera, determining whether the camera is a manual mode of switching the parametric model; if it is a manual mode of switching the parametric model, then proceed to step 5, if it's not a manual mode of switching the parametric model, then proceed to the next step;
step 2, detecting whether the camera is currently in a photographing scene in water by the external sensor, if not, proceed to the next step; if yes, proceed to step 4;
step 3, correlating the acquired image with stored parameters for air application scene, and retrieving the stored air parametric model;
step 4, correlating the acquired image with the stored parameters for water application scene, and retrieving the stored water parametric model;
step 5, manually switching the camera to an air parametric model, correlating the acquired image with the stored parameters for air application scene and retrieving the stored air parametric model, or manually switching the camera to a water parametric model, correlating the acquired image with the stored parameters for water application scene and retrieving the stored water parametric model.

5. The photographing method compatible in air and water according to claim 2, wherein the parameters for water application scene comprise parameters for seawater application scene and parameters for freshwater application scene.

6. The photographing method compatible in air and water according to claim 3, wherein the set value is 3%-10%.

7. The photographing method compatible in air and water according to claim 4, wherein the external sensor comprises a pressure sensor or a waterlogging sensor.

8. The photographing method compatible in air and water according to claim 1, wherein the camera is a photographing device A or a photographing device B;
the photographing device A comprises two or more photographing units, and the photographing unit comprises an image sensor; the photographing device A further comprises a main control unit, and the main control unit comprises a main controller, and a main memory connected with the main controller;
the photographing device B comprises two or more photographing units, and the photographing unit comprises an image sensor and an image processor and an image memory that are electrically connected with the image sensor.

9. (canceled)

10. (canceled)
